(19) United States
(12) Patent Application Publication
(10) Pub. No.: US 2008/0105495 A1
(43) Pub. Date: May 8, 2008

(54) Device for Automatic Product Distribution

(76) Inventors: Alain Mazzoni, Bouc Bel Air (FR); Jean Noel Ellies, L'Isle Sur La Sorgue (FR)

Correspondence Address: GREENBLUM & BERNSTEIN, P.L.C., 1950 ROLAND CLARKE PLACE, RESTON, VA, 20191, US

(21) Appl. No.: 11/570,594

(22) PCT Filed: Jun. 15, 2005
(86) PCT No.: PCT/FR05/01484

§ 371 Date: Jun. 21, 2007

(30) Foreign Application Priority Data
Jun. 16, 2004 (FR) 0406507

(51) Int. Cl. B65G 1/137; G06F 17/00

(52) U.S. Cl. 186/55; 700/231; 700/262; 901/2

(57) ABSTRACT

The invention concerns a device for automatic product distribution. The invention concerns the technical field of installations provided in small, medium and large surface distribution shops and permitting a user to order and pay remotely or on the spot selected products and to collect them with his vehicle. The inventive device for automatic product distribution is fitted in a location where the products (6) of a distribution shop are available, comprises (1) means for remotely ordering a list of products, a management computer terminal (2), and one or several delivery tracks (5) for motor vehicles (10). An automatic delivery system (3) enabling boxes of orders (8) wherein are arranged ordered products to be routed from said location where the products are available to said delivery tracks, is provided with at least one automatic device for storing (4) said boxes. The invention enables products to be remotely ordered and paid for by a user and said ordered products to be collected directly near his vehicle, the ordered products being delivered without human intervention.

The invention relates to the technical field of installations provided in small, medium, or large distribution stores, and allowing a user to order and pay remotely or on the spot the products he has selected, and to come and pick them up with his vehicle.

Clients who shop in a distribution store scour the various aisles to retrieve the products they want. These products are usually placed in a basket or, if they are numerous or heavy, in a shopping cart.

This method of operation is convenient, since a large number of varied products can be selected in the same location. However, walking up and down the aisles and waiting at the checkout can result in a substantial waste of time when the store is crowded.

To spare the users from wasting time when shopping, delivery devices are known that equip distribution stores, allowing a user to remotely order a list of products, for example via the Internet, and to submit this list to a preparer who selects and groups together the various selected products. The user can then pick up his order directly inside the store or by parking his vehicle in a parking space provided for this purpose, a delivery person bringing the order up to the trunk of said vehicle.

These solutions are however not satisfactory since they have a high labor cost and require from the client to pick up his order during the store opening hours.

Furthermore, these solutions do not allow managing orders placed several hours ahead of time, since no device enabling to put orders on hold has been provided.

The object of the present invention is to overcome this drawback; in particular, by enabling the user to order and pay for a list of products remotely, and to pick up his order directly near his vehicle, the delivery of the products ordered being carried out without any human intervention.

Another object of the invention is to enable the user to pick up his order at any given time, seven days a week, twenty-four hours a day, even when the store is closed.

Another object of the invention is to prevent perishable food products from spoiling when orders that have been filled are on hold.

Another object of the invention is to make preparing orders easier.

Another object of the invention is to be able to easily adapt the structure of the delivery device, object of the invention, to the dimensions and management capacity of the distribution stores, which will be equipped with the device.

These objects are achieved by an automatic product distribution device arranged in the location where the products of a distribution store are available, comprising means for remotely ordering a list of products, a management computer terminal, one or several delivery tracks for motor vehicles, characterized in that an automatic delivery system enabling the order boxes, in which the products ordered are arranged, to be routed from the location where the products are available to the delivery tracks, is arranged with at least one automatic storage device so that the products ordered are automatically delivered at a time of choice for the user, without any outer human intervention.

More particularly, these goals are achieved due to the fact that the automatic delivery system comprises:
An “outward” mechanical routing device comprising a first portion that allows routing the order boxes from the location where the products are available to the automatic storage device, and a second portion that allows routing the order boxes from the automatic storage device to the delivery tracks;
selection means controlled by the computer terminal allowing directing the order boxes toward the predetermined delivery tracks;
advantageously, a “return” mechanical routing device for the empty order boxes, from the delivery tracks to the location where the products are available, in the case the user does not pick up said boxes;
   so that managing the order boxes is facilitated and independent of human intervention.

These objects are also achieved due to the fact that the automatic storage device comprises a robot-manipulator and storage containers that can contain the order boxes in order to automatically manage the orders prepared ahead of time and on hold to be delivered.

These objects are also achieved due to the fact that the storage containers can be modulized so as to adapt to the management capabilities of the stores equipped with the distribution device, object of the invention.

These objects are also achieved due to the fact that the device, object of the invention, comprises means for maintaining the products ordered at a set temperature, whether positive or negative, so as to prevent perishable products from deteriorating when the order boxes are on hold in the storage device.

These objects are also achieved due to the fact that the computer system for managing orders u ses an application that reorders the list of products ordered by a client depending upon the position of said products in the location where the products are available, so as to make preparing orders easier.

These objects are also achieved due to the fact that the delivery tracks can be modulized so as to enable the structure of the delivery device, object of the invention, to easily adapt to the dimensions and management capability of the distribution stores, which will be equipped with the device will.

In an alternative embodiment, these objects are also achieved due to the fact that automatic storage devices are arranged above each delivery track to improve the management of the orders, which are prepared and on hold.

In another alternative embodiment, these objects are achieved due to the fact that the automatic delivery system comprises:
an “outward” mechanical routing device comprising a first portion that allows routing the order boxes from the location where the products are available to the automatic storage device, and a second portion that allows routing the order boxes from the automatic storage device to the delivery tracks;
advantageously, a “return” mechanical routing device for the empty order boxes, comprising a first portion that allows routing the empty order boxes from the delivery tracks to the automatic storage device, and a second portion that allows routing said order boxes from said automatic storage device to the location where the products are available,
   so that managing the order boxes is facilitated and independent of any human intervention.

In this other alternative embodiment, these objects are also achieved due to the fact that the automatic storage device comprises a continuous transportation means looping around the delivery tracks in order to automatically manage the orders prepared ahead of time and on hold for delivery.

Other characteristics and advantages of the present invention will be better understood upon reading the description that follows, given as a non-limiting example, in reference to the annexed drawings, in which:

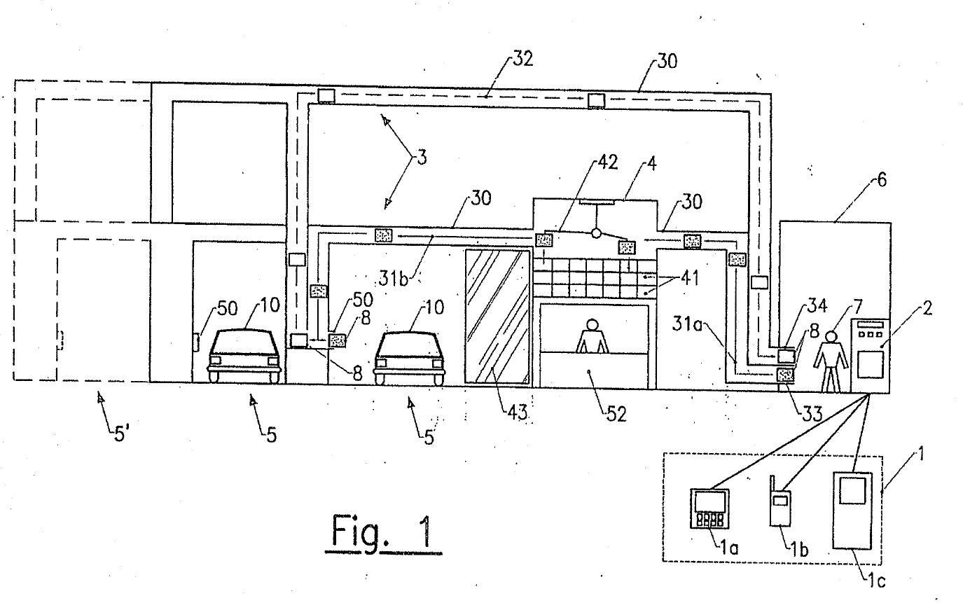

FIG. 1 is a schematic view of the device, object of the invention, showing the various constituting elements;

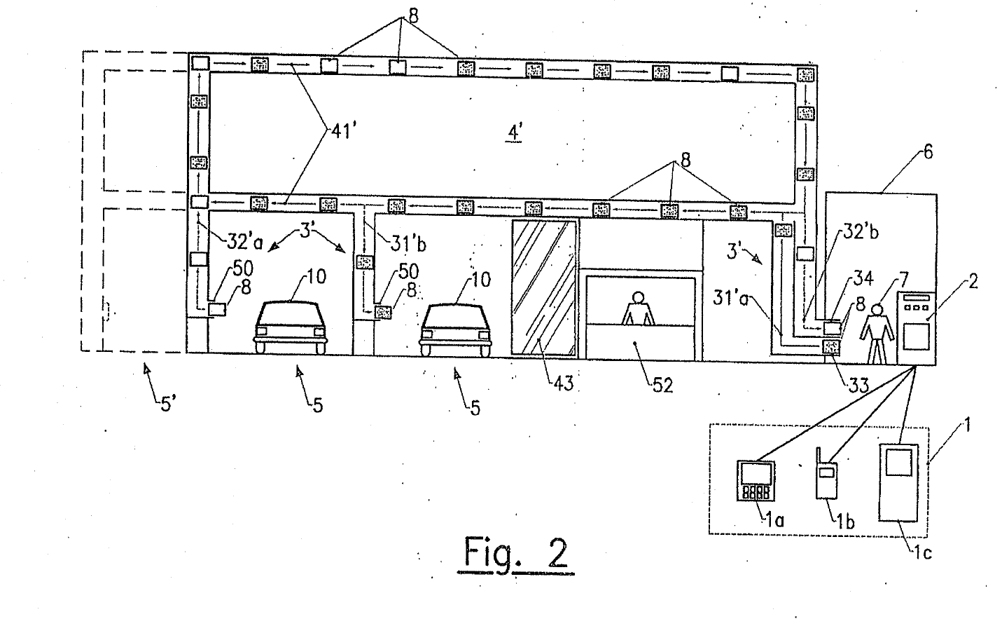

FIG. 2 is a schematic view of the device, object of the invention, in an alternative embodiment;

The distribution device, object of the invention, is adapted to equip distribution stores offering a wide selection of consumer goods to the general public.

It is preferably located, from a computer processing and logistical standpoint, in the parking lot of a distribution store and is connected to the location 6 where the products of the latter are available (for example the warehouse).

It enables a user, either remotely or on the spot, to order and pay for the products of his choice offered in the distribution stores equipped with the distribution device according to the invention, and to pick them up with his vehicle 10 whenever he wishes to.

Referring to FIG. 1, the distribution device, object of the invention, comprises ordering means 1, a computer terminal 2, which, in particular, manages the information relative to the products, users, and orders, an automatic system 3 for delivering the products ordered, at least one automatic device 4 for storing the prepared orders on hold for distribution, and one or several delivery tracks 5.

Products can be ordered via computers 1a connected to the Internet, via phones or fax-machines 1b, via touch screen terminals 1c located in various strategic locations of the stores, or by any other equivalent means. These ordering means 1 enable a user to remotely select a list of products and to transmit this list to the computer terminal 2.

Advantageously, the computer terminal 2 systematically proposes a similar product to the user, in the case the product ordered is not available.

To save time, the user can use simplified order suggestions.

Advantageously, all the previous orders of a client are saved and processed by the computer terminal 2 to analyze the consumption habits and possibly provide the user with a customized order proposal. The analysis of the previous orders further enables the user to benefit from possible discounts (such as discount vouchers) to which he is entitled.

When the user validates his order, he is given an order code, which he will need to pick up the products.

The user can pay for his order remotely via the Internet by giving his payment card number, or by going to automatic check-outs located in the vicinity of the delivery tracks 5.

Once the order has been validated, the list of selected products is transmitted to the computer terminal 2.

This computer terminal launches an application that allows sorting the list of products in logical order depending upon their position in the aisles of the location 6 where the products are available, so as to optimize the circuit progression of the preparer 7 in said aisles in order to make preparing the orders easier and as fast as possible.

To efficiently prepare orders, the preparer has a cart provided with a visual unit displaying the list of products sorted in logical order and their position in the aisles of the location 6 the products are available.

The preparer groups the selected products in an order box 8 arranged on his preparation cart.

The dimensions of the order boxes are preferably adapted to relatively compact products, of the food type, but other systems can be provided for bulkier products.

Various order boxes can be used: isotherm boxes, for example made of polystyrene, that allows keeping frozen or fresh products at a controlled temperature for ensuring their preservation for a few hours, and simple boxes, made of rigid plastic or cardboard, for example, for all other products.

In an alternative embodiment, the order boxes are compartmentalized according to the characteristics of the selected products (fresh products, frozen products, other products), by means of isotherm compartments.

A bar code corresponding to the user order number is placed on one of the surfaces of the order box to allow locating and more easily managing the orders; any other equivalent means can be used.

The cart of the preparer is advantageously provided with an optical means for reading the bar codes placed on the selected products so as to check their conformity with the products ordered by the user and prevent the preparer from making mistakes.

Once the order has been prepared, the preparer 7 arranges the full order boxes (shown hatched in the annexed drawings) in the loading station 33 located in the location 6 where the products are available, and which communicates with the automatic delivery system 3 that is capable of automatically routing said order boxes.

Advantageously, a means for taking photographs of the content of each order box is provided in the area of the loading station 33. These photographs are memorized with the order reference number by the computer terminal 2 in order to have a proof in case of a dispute, or to avoid possible frauds.

This automatic delivery system, protected by a protection channel 30, comprises:
an “outward” mechanical routing device comprising a first portion 31a that allows routing the order boxes 8 from the location 6 where the products are available to the automatic storage device 4, and a second portion 31b that allows routing the order boxes from the automatic storage device 4 to the delivery tracks 5, without human intervention;
selection means controlled by the computer terminal 2 that allows directing the order boxes 8 toward the predetermined delivery tracks 5;
advantageously, a “return” mechanical routing device 32 for the empty order boxes (shown non hatched in the annexed drawings), from the delivery tracks 5 to the location 6 where the products are available.

The automatic delivery system 3 can be arranged along a vertical or horizontal plane.

As soon as an order box is engaged in the loading station 33, the first portion 31a of the “outward” mechanical routing device drives it toward the automatic storage device 4 by means of a conveyor belt or of mechanical lifts mounted on cables, or of any other equivalent transportation means.

The automatic storage device 4 allows managing the order boxes prepared ahead of time and on hold for delivery.

The order boxes 8 containing the products to be delivered are stored in storage containers 41 due to a robot 42, of the manipulator type, controlled by the computer terminal 2.

A number is assigned to each storage container, the computer terminal 2 matching the storage container number with the order number, so as to mark the position of order boxes in the automatic storage device 4.

Each storage container 41 is provided with a presence sensor indicating the presence of an order box.

The computer terminal 2 analyses the configuration of the storage device 4, that is, the number and position of the order boxes 8 and the number and position of empty containers, and instructs the robot 42 to take the order boxes present on the first portion of the device 31a of the “outward” mechanical routing device and to orderly arrange them in the storages containers available. The order boxes 8 are then stored on hold until picked up by the users.

An air conditioner and an insulating sheath are advantageously provided in the automatic storage device 4 to maintain a set temperature, whether positive or negative, inside said device for adequately preserving food-type products.

The automatic storage device can also be compartmented depending upon the product type, for example, dry, fresh, and frozen product, each compartment having a controlled temperature that is adequate for preserving various types of products.

According to a preferred embodiment, the storage containers 41 can be modulized so as to easily increase or decrease the number of containers, depending upon the management capabilities of the distribution stores, which will be equipped with the distribution device, object of the invention.

A zone for technical intervention 43 is advantageously provided in the vicinity of the automatic storage device 4 to provide a technician with easy access thereto in the case an intervention is needed in one of the constituting elements.

As soon as an order box 8 is on hold in the automatic storage device 4, the computer terminal 2 launches an application that signals the user that his order is ready to be delivered.

The signaling means can be a message delivered via the Internet, a phone message, a message sent by facsimile, a visual message available on information displays located in the distribution store, or any other equivalent means.

In the case where some products ordered are fresh or frozen food products, the signaling means indicates the latest time for pick up, beyond which these products may spoil.

The signaling means can further indicate the number of the delivery track where the order will be delivered. The computer terminal 2 is able to analyze the usage rate of the device, object of the invention, based on the time range, the days of the week, the periods, so as to anticipate times of high activity in order to deliver the fastest possible service and to determine the delivery track where the user would have the least waiting time to pick up his delivery.

As soon as the user is informed that his order is ready, he can be pick up his order whenever he chooses to, by parking his vehicle 10 on the delivery track 5 indicated on the signaling means, or on any other track if the user is not given a track number.

According to a preferred embodiment, the delivery tracks are arranged on the parking lot of the distribution store.

The delivery tracks can be modulized and, as shown in the annexed drawings in dotted lines, extensions 5′ can be envisioned to allow the structure of the delivery device, object of the invention, to easily adapt to the dimensions and management capability of distribution stores.

An information display provided with a keyboard is positioned in the area of each delivery track, enabling the user to key in his order code.

Intercoms and/or videophones are arranged in the vicinity of the information display provided with a keyboard to enable the user to request assistance.

If the user has not already paid for his order, automatic check outs are provided.

After the order code has been validated and/or the corresponding order has been paid at the automatic check out, the computer terminal 2 activates the robot 42 to make it retrieve the order box corresponding to the order code keyed in and position the order box on the second portion 31b of the “outward” mechanical routing device.

The order boxes are then mechanically routed by means of a conveyor belt or of mechanical lifts mounted on cables, or of any other equivalent transportation means, toward the delivery tracks 5.

Selection means controlled by the computer terminal 2 allow directing the order boxes toward the delivery track 5 where the user is waiting.

As shown in FIG. 1, a reception opening 50 located in the vicinity of the delivery track 5 enables the user to retrieve the products from the order box and to arrange them in the trunk of his vehicle, in the case where the store takes the order boxes back. Should it be otherwise, the user can pick up the order box and directly put it in the trunk of his car.

According to a preferred embodiment, a reception are/office 52 is provided in the vicinity of the delivery tracks 5 to welcome, advise, and guide users.

Several touch screens and automatic check outs are available for users to pay for their order on the spot.

To make good use of the user's time while waiting for the preparation of the products he has selected, when the user places his order directly from the reception area/office, equipments and services, such as photographs drop off, automatic teller machines, paper kiosk, screens with information on travels and shows, are provided.

As soon as the order is ready, an information screen located in the reception area/office informs the user the products can be picked up.

When the empty order boxes, shown non hatched in FIG. 1, are to be collected by the store, a “return” mechanical routing device 32 is provided to automatically bring said boxes back from the delivery track 5 to the location 6 where the products are available.

The order boxes are thus mechanically routed by a conveyor belt or mechanical lifts mounted on cables, or any other equivalent transportation means.

The preparer 6 then collects the empty order boxes in the area of the unloading station 34 located in the location 6 where the products are available.

According to a preferred embodiment, a means for cleaning and keeping the empty order boxes clean, such as, for example, spraying hot steam inside said boxes, is provided in the area of the “return” mechanical transportation device 32.

In an alternative embodiment that is not shown, the single automatic storage device 4 previously described can be replaced by similar automatic storage devices arranged above each delivery track.

The number of the delivery track where the order will be delivered is indicated together with the order number, or later, for example by means of a general information display located in the vicinity of the delivery track, said track being determined so that the prepared order boxes are equally distributed in the various automatic storage devices in order to optimize the delivery time and improve the management of orders.

The user therefore parks his vehicle on the predetermined delivery track and keys in his order code and/or makes the corresponding payment to be delivered in a similar way as that previously described.

Another alternative embodiment of the invention is shown in FIG. 2.

The reference numerals in FIG. 2, similar to the reference numerals in FIG. 1, relate to the same constitutive elements of the invention, only the arrangement of the automatic delivery system and the operating mode of automatic storage device differ from the previous description.

The automatic delivery system 3′ comprises:
an “outward” mechanical routing device comprising a first portion 31′a that allows routing the order boxes from the location where the products are available to the automatic storage device 4′, and a second portion 31′b that allows routing the order boxes from the automatic storage device to the delivery tracks 5;
advantageously, a “return” mechanical routing device comprising a first portion 32′a that allows routing the empty order boxes from the delivery tracks 5 to the automatic storage device 4′, and a second portion 32′b that allows transporting the empty order boxes from the automatic storage device to the location where the products are available.

The automatic delivery system 3′ can be arranged along a vertical or horizontal plane.

In the embodiment shown in FIG. 2, the automatic storage device 4′ is of the dynamic type, comprising a continuous transportation means 41′, of the conveyor belt type or any other equivalent means, looping around each delivery track 5. In a similar way, an automatic storage device 4′ can be arranged above each delivery track 5.

The continuous transportation means 41′ comprises storage containers in which the order boxes 8 are arranged.

As previously described, the preparer 7 places the full order boxes 8 (shown hatched) in the loading station 33 located in the location 6 where the products are available.

The first portion 31′a of the “outward” mechanical routing device allows routing said boxes by means of a conveyor belt, clamps, or any other equivalent means, up to inside the storage containers available on the continuous transportation means 41′.

A number is assigned to each storage container, the computer terminal 2 matching the container number with the order number in order to mark the position of the order boxes in the automatic storage device 4′.

An air conditioner and an insulating sheath are advantageously provided in the automatic storage device 4′ to maintain a controlled temperature directed inside said device in order to adequately preserve food-type products.

As soon as the user is informed that his order is ready, he parks his vehicle 10 on one of the delivery tracks 5.

After the order code has been validated and/or the corresponding order has been paid for at the automatic check out, the computer terminal 2 actuates the continuous transportation means 41′.

This transportation means loops around the delivery tracks 5 until the container in which the order of the user is placed arrives at the level of the delivery track where said user is parked, the second portion 31′b of the “outward” mechanical routing device making it possible to bring the order boxes, by means of a conveyor belt, clamps, or any other equivalent means, from the automatic storage device to the reception opening 50.

When the empty order boxes, shown non hatched in FIG. 2, are taken back by the store, the first portion 32′a of the mechanical routing device automatically brings said boxes from the delivery track 5 to the automatic storage device 4′. In a preferred embodiment, this first portion 32′a is equivalent to the second portion 31′b of the “outward” mechanical routing device, the mechanical means used for transporting the order boxes functioning in a reverse manner.

The empty order boxes are then positioned in the storage containers available on the continuous transportation means 41′ and, when the latter turns, said boxes arrive at the level of the second portion 32′b of the “return” mechanical routing device and are transported, by means of a conveyor belt, clamps, or any other equivalent means, to the unloading station 34 located in the location where the products are available.

According to a preferred embodiment, a means for cleaning and keeping the empty order boxes clean, such as, for example, spraying hot steam inside said boxes, is provided at the level of the second portion 32′b of the “return” mechanical routing device.

The presence and positioning of the various constitutive elements give the object of the invention a maximum of useful effects that have not, until this day, been achieved by similar devices.

1. Device for automatic product distribution being arranged in a location where the products (6) of a distribution store are available, comprising means (1) for remotely ordering a list of products, a management computer terminal (2), one or several delivery tracks (5) for motor vehicles (10), characterized in that an automatic delivery system (3, 3′) allowing routing order boxes (8) in which the ordered products are placed, from said location where the products are available to said delivery tracks, is arranged with at least one device (4, 4′) for automatically storing said boxes.

2. Device for automatic distribution according to claim 1, characterized in that the automatic delivery track (3) comprises:
An “outward” mechanical routing device comprising a first portion (31a) that allows routing the order boxes (8) from the location where the products (6) are available to the automatic storage device (4), and a second portion (31b) that allows routing the order boxes from the automatic storage device (4) to the delivery tracks (5);
selection means controlled by the computer terminal (2) allowing directing the order boxes (8) toward the predetermined delivery tracks (5).

3. Device for automatic distribution according to claim 1, characterized in that the automatic storage device (4) comprises a robot-manipulator (42) and storage containers (41) that can be modulized.

4. Device for automatic distribution according to claim 1, characterized in that the automatic delivery system (3′) comprises an “outward” mechanical routing device comprised of a first portion (31′a) allowing routing the order boxes from the location where the products are available to the automatic storage device (4′), and of a second portion (31′b) allowing routing the order boxes from the automatic storage device to the delivery tracks (5).

5. Device for automatic distribution according to claim 4, characterized in that the automatic storage device (4′) comprises a continuous transportation means (41′) comprising storage containers, looping around the delivery tracks (5).

6. Device for automatic distribution according to claim 1, characterized in that the automatic delivery system (3, 3′) comprises a “return” mechanical routing device (32, 32′a/32′b) for the empty order boxes (8) from the delivery tracks (5) to the location where the products (6) are available.

7. Device for automatic distribution according to claim 1, characterized in that the order boxes (8) comprise means for preserving the products ordered.

8. Device for automatic distribution according to claim 1, characterized in that the computer terminal (2) uses an application that reorders the list of products ordered by a client depending upon the location of said products in the warehouse (6).

9. Device for automatic distribution according to claim 1, characterized in that it comprises a means for cleaning the order boxes (8).

10. Device for automatic distribution according to claim 1, characterized in that the delivery tracks (5) can be modulized.

11. Device for automatic distribution according to claim 1, characterized in that it comprises a means for taking photographs of the content of each order box (8).

12. Device for automatic distribution according to claim 1, characterized in that an automatic storage device (4, 4′) is arranged above each delivery track (5).
